(19) United States
(12) Patent Application Publication
(10) Pub. No.: US 2026/0066747 A1
(43) Pub. Date: Mar. 5, 2026

(54) A MOTOR BASE, A VOICE COIL MOTOR, AND THEIR MANUFACTURING METHOD

(71) Applicant: SUZHOU GYZ ELECTRONIC TECHNOLOGY CO., LTD, Suzhou (CN)

(72) Inventors: Yuanzhen ZHU, Suzhou (CN); Wei Hu, Suzhou (CN); Xingxing LIU, Suzhou (CN); Couquan MO, Suzhou (CN)

(21) Appl. No.: 19/103,695

(22) PCT Filed: Aug. 9, 2023
(86) PCT No.: PCT/CN2023/111974

§ 371 Date: Feb. 13, 2025

(30) Foreign Application Priority Data
Apr. 26, 2023 (CN) 202310461356.4

(51) Int. Cl. H02K 11/215; G02B 7/09; H02K 15/12; H02K 41/035

(52) U.S. Cl. CPC H02K 11/215; G02B 7/09; H02K 15/12; H02K 41/0354; H02K 2211/03

(57) ABSTRACT

A motor base, a voice coil motor and a manufacturing method thereof are disclosed. The motor base includes a plurality of metal branches, an insulating base injection-molded on the plurality of metal branches, at least one first electronic component mounted on the insulating base and electrically connected to the metal branches, and a high-density integrated circuit module. The high-density integrated circuit module includes a rigid circuit board and a high-density integrated circuit soldered to the rigid circuit board. The rigid circuit board is provided with a plurality of conductive sheets arranged at intervals. The conductive sheets are electrically connected to the metal branches embedded in the insulating base, so that the high-density integrated circuit is electrically connected to the first electronic component through the metal branches. It can more reasonably utilize the circuit layout space of the motor base, allowing the high-density integrated circuit to utilize a larger space.

### TECHNICAL FIELD

The present disclosure relates to the technical field of motor manufacturing, and more particularly to a motor base, a voice coil motor, and their manufacturing method.

### BACKGROUND

The voice coil motor is an important component for camera focus adjustment and anti-shake, usually including a motor base and a magnetic structure and other driving components. The motor base is embedded with a metal circuit and a coil formed by winding or assembled by mounting. The magnetic structure and other driving components are used to connect with the lens, and they interact with the coil to drive the magnetic structure and the lens to move by changing the DC current of the coil in the motor.

The motor base can be applied to the camera module in the mobile phone. Due to the thickness of the mobile phone, the horizontally placed mobile phone camera can only have a small focal length, and the optical zoom capability is very limited. The periscope voice coil motor can solve this problem well. The periscope voice coil motor is different from the parallel arrangement of the traditional dual-camera lens. The camera originally arranged vertically is arranged horizontally in the mobile phone, and a special optical prism is used to refract light into the lens group to achieve imaging, which can greatly increase the focal length of the camera.

Compared with the voice coil motor in the prior art, the structure of the periscope voice coil motor is relatively complex. In addition to the photosensitive component and the optical lens, it also includes a reflective element for changing the propagation direction of the ambient light. For details, please refer to the Chinese invention patent application with the publication number CN113328586A. The photosensitive component, the optical lens and the reflective element all need to sense the position of their movement in all directions. Therefore, in order to achieve more refined drive control, the periscope voice coil motor needs to set up more sensing elements or computing processing to cooperate with the processing of some sensing signals, computing and feedback control of the current size. In addition, these structures all need to be driven or anti-shake controlled, resulting in the need for the periscope voice coil motor to install more sensors for position monitoring on the base and set up a processor (Central Processing Unit, CPU) or integrated circuit (integrated circuit, IC) that provides more powerful computing control capabilities.

In the prior art, voice coil motors are usually equipped with various integrated circuits (ICs). For example, the driver IC used to drive the coil is usually integrated with a Hall sensor, which can only be arranged in a centralized location and can only control a single sensor. If the voice coil motor needs more sensors to sense and control the dynamics at more locations, more driver ICs with integrated Hall sensors are needed to achieve this. In addition, since in the prior art, the driver IC can only be integrated with the sensor at the same location, there is no way to arrange the sensor more flexibly (the sensor and coil are relatively small, while the driver IC is usually relatively large), and there is no way to arrange the driver IC in a more suitable and flexible location. The voice coil motor in the prior art requires a small number of coils and sensors, and the coils and sensors require a small number of control circuits. Therefore, the coils and sensors can be directly soldered and integrated with the metal circuits in the base of the motor base in a more convenient way (for example, the metal circuit in the base is formed by a single stamping method, and then soldered with the coil or sensor, and finally bent or arranged directly at the sensing position without bending). The driver integrated circuit (Driver IC) with multiple coil or sensor control capabilities needs to have built-in complex computing control functions, so more circuit structures need to be arranged to form a new generation of high-density integrated circuits (HDIC). The metal circuit in the base of the motor base in the prior art is limited by the base size, and its circuit layout space is limited. At the same time, the metal circuit is also limited to a certain extent by the stamping process for the minimum size of the metal circuit, resulting in the inability to integrate more metal circuits in the limited circuit layout space of the base, and thus its circuit layout capability can no longer meet the requirements of the integrated layout of such high-density integrated circuits and metal circuits in the base.

Therefore, it is necessary to provide a motor base and a voice coil motor having the same, which can more reasonably utilize the circuit layout space of the motor base, so that the control circuit of the high-density integrated circuit can utilize a larger space to achieve richer control functions.

### SUMMARY

The present disclosure aims to solve at least one of the technical problems raised in the above background technology, and proposes a motor base and a voice coil motor having the same, and a method for manufacturing the motor base, which can more reasonably utilize the circuit layout space of the motor base, so that the control circuit of the high-density integrated circuit can use a larger space to achieve richer control functions.

The technical solution adopted by the present disclosure to solve the existing technical problems is: a motor base, including a plurality of metal branches, an insulating base injection-molded on the plurality of metal branches, at least one first electronic component installed on the insulating base and electrically connected to the metal branches, and a high-density integrated circuit module, the high-density integrated circuit module including a rigid circuit board and a high-density integrated circuit soldered to the rigid circuit board, the rigid circuit board is provided with a plurality of conductive sheets arranged at intervals, the conductive sheets are electrically connected to the metal branches embedded in the insulating base, so that the high-density integrated circuit is electrically connected to the first electronic component through the metal branches.

Further, the high-density integrated circuit has at least eight solder joints, the rigid circuit board has at least eight solder pads corresponding to the eight solder joints and fixed by soldering, the rigid circuit board forms a plurality of circuits electrically connecting the corresponding solder pads and the conductive sheet, and the conductive sheet of the rigid circuit board is fixed by soldering to the metal branches in the insulating base.

Further, the first electronic component includes a first sensing element with a position sensing function and a first coil, the first sensing element and the first coil are directly soldered to the corresponding metal branches, the high-density integrated circuit module is electrically connected to the first sensing element and the first coil through the metal branches, and then outputs a control signal to control the current to drive the first coil after the sensing function is realized according to the first sensing element.

Further, at least one end of the metal branches are provided with soldering feet arranged at intervals around the periphery of the rigid circuit board, the conductive sheet is arranged on the periphery of the rigid circuit board and fixed by soldering to the corresponding soldering feet.

Further, the insulating base is recessed inward to form a mounting groove, the high-density integrated circuit module is accommodated in the mounting groove, and at least part of the soldering feet of the metal branches are embedded in one side or the periphery of the mounting groove.

Further, a platform is formed on the periphery of the mounting groove, the mounting groove includes a recessed portion recessed from the platform, and the rigid circuit board is accommodated in the recessed portion.

Further, the platform is provided with a plurality of pits corresponding to the soldering feet of the metal branches, the soldering feet are embedded in the corresponding pits to be exposed outside the insulating base, and a partition block is formed between two adjacent pits.

Further, the conductive sheet of the rigid circuit board and the corresponding soldering feet are arranged opposite to each other along the length or width direction of the soldering feet and are connected to each other by solder paste.

Further, the surfaces where the conductive sheet of the rigid circuit board and the soldering feet are soldered to each other are located in the same plane.

Further, the conductive sheet of the rigid circuit board and the corresponding soldering feet are stacked and connected to each other by solder paste along the thickness direction of the soldering feet.

Further, the rigid circuit board is provided with a via hole, the circuits are formed on opposite sides of the rigid circuit board and is electrically connected through the via holes, the conductive sheet is located on one side of the rigid circuit board and is electrically connected to the corresponding circuit on the other side of the rigid circuit board through the via holes.

Further, the rigid circuit board is a ceramic substrate or a rigid printed circuit board or an integrally formed part of an etched circuit and a plastic base.

Further, when the rigid circuit board is a ceramic substrate, the surfaces of opposite sides of the ceramic substrate are plated to form the conductive sheet and the circuit electrically connected to the conductive sheet, and the line width of the circuit is greater than or equal to 20 microns and less than or equal to 70 microns.

Further, the high-density integrated circuit is fixed to the rigid circuit board by soldering with a first solder paste, and the conductive sheet of the rigid circuit board is fixed to the metal branches by soldering with a second solder paste. The melting point of the first solder paste is greater than the melting point of the second solder paste. The high-density integrated circuit and the rigid circuit board, as well as the rigid circuit board and the metal branches, are both fixed by soldering with reflow soldering.

Furthermore, the rigid circuit board is also electrically connected to a number of capacitor elements. Furthermore, the insulating base includes at least two separately arranged insulating blocks that are once injection molded on the metal branches and an insulating base body that is twice injection molded on the insulating blocks and the metal branches, and the high-density integrated circuit module and the first electronic component are respectively arranged on at least two of the insulating blocks.

Further, the insulating base body includes a horizontally arranged bottom and a first side wall and a second side wall that are vertically and oppositely arranged, the insulating blocks include a first insulating block and a second insulating block that are spaced and embedded in the first side wall, and a third insulating block that is embedded in the second side wall and opposite to the second insulating block, the high-density integrated circuit module is fixed to the first insulating block, and the second insulating block and the third insulating block are both provided with the first electronic component.

Furthermore, the insulating blocks further includes a fourth insulating block embedded in the second side wall and spaced apart from the third insulating block, a second electronic component is mounted on the fourth insulating block, at least part of the metal branches are provided with a soldering end exposed to the fourth insulating block, the soldering end is electrically connected to the second electronic component, the second electronic component includes a second coil and a sensing chip for controlling the operation of the second coil arranged at the center of the second coil, and the high-density integrated circuit module is arranged opposite to the second electronic component.

The present disclosure provides a voice coil motor, including the motor base and a first optical module matched with the motor base and located at the first electronic component, the first optical module is fixed with an optical element and includes a first magnetic element matched with the first electronic component.

The present disclosure also provides another voice coil motor, including the motor base and a second optical module matched with the motor base and located at the second electronic component, the second optical module includes a second magnetic element matched with the second electronic component.

The present disclosure also provides a method for manufacturing the motor base, comprising the following steps:
S1, providing a plurality of the metal branches;
S2, injection molding at least a portion of the insulating base on the metal branches;
S3, installing at least one of the first electronic components on the insulating base and electrically connecting the metal branches;
S4, providing a rigid circuit board, the rigid circuit board being provided with a plurality of the conductive sheets arranged at intervals, soldering the high-density integrated circuit to the rigid circuit board to form a high-density integrated circuit module, and electrically connecting the conductive sheets arranged on the rigid circuit board to the metal branches embedded in the insulating base, so that the high-density integrated circuit is electrically connected to the first electronic component through the metal branches.

Further, in the manufacturing method of the motor base:

In S1, in the initial state, several of the metal branches are arranged horizontally;

In S2, three of first insulating blocks, second insulating blocks and third insulating blocks which are arranged separately are injection molded at the metal branches at one time to form a part of the insulating base, and the first insulating block, the second insulating block and the third insulating block are all arranged horizontally;

In S3, the first electronic component is horizontally mounted on the second insulating block and the third insulating block and directly soldered to the corresponding metal branches;

In S4, the high-density integrated circuit module is horizontally mounted on the first insulating block, and the conductive sheets of the rigid circuit board are soldered to the corresponding metal branches.

Furthermore, the manufacturing method of the motor base also includes the following steps:

S5, bending the metal branches so that the first insulating block, the high-density integrated circuit module installed on the first insulating block, the second insulating block, the third insulating block and the first electronic component installed on the second insulating block and the third insulating block are all converted from a horizontal position to a vertical position: S6. Performing secondary injection molding on the metal branches, the first insulating block, the second insulating block and the third insulating block to obtain an insulating base body, thereby forming the insulating base.

Beneficial effects of the present disclosure:

The above motor base integrates a high-density integrated circuit, so that the high-density integrated circuit is combined and connected with the first electronic component through the metal branches. Compared with the split control form in the prior art that uses multiple driving integrated circuits to control multiple electronic components respectively, the above motor base uses a high-density integrated circuit to control multiple electronic components at the same time, that is, using integrated control instead of the split control of the prior art, so that the high-density integrated circuit can achieve richer control functions. The high-density integrated circuit module can be integrated with the electronic components it controls or separately arranged, that is, the position of the high-density integrated circuit module is not limited to a position adjacent to the electronic components it controls. Through this arrangement, the positions of the high-density integrated circuit module and the electronic components can be dispersed to achieve a more flexible spatial layout. In addition, the high-density integrated circuit is independently arranged on a rigid circuit board, which is more suitable for integrating complex circuits without burdening the spatial arrangement of metal branches in the insulating base. The circuit layout space of the motor base can be more reasonably utilized, and the control capability of the motor base and the voice coil motor with it can be more refined, allowing the high-density integrated circuit to utilize a larger space to achieve richer control functions.

### BRIEF DESCRIPTION OF THE DRAWINGS

FIG. 1 is a schematic diagram of the three-dimensional structure of the motor base of the first embodiment of the present disclosure.

FIG. 2 is a three-dimensional view of the motor base shown in FIG. 1 at another perspective.

FIG. 3 is a schematic diagram of the structure of the motor base of the first embodiment of the present disclosure after removing the insulating base body.

FIG. 4 is an enlarged view of part of the structure in FIG. 3.

FIG. 5 is an enlarged view of FIG. 4 at A.

FIG. 6 is a decomposition view of part of the structure in FIG. 3.

FIG. 7 is a schematic diagram of the structure of the high-density integrated circuit facing the side of the rigid circuit board in FIG. 6

FIG. 8 is a schematic diagram of the structure of FIG. 3 after removing the insulating blocks.

FIG. 9 is an enlarged view of FIG. 8 at B.

FIG. 10 is a three-dimensional view of FIG. 8 at another perspective

FIG. 11 is an enlarged view of FIG. 10 at C.

FIG. 12 is a schematic diagram of the three-dimensional structure of the motor base of the second embodiment of the present disclosure.

FIG. 13 is a structural diagram of the motor base of the second embodiment of the present disclosure at the high-density integrated circuit module after removing the insulating base body.

FIG. 14 is a structural diagram of FIG. 13 at another perspective after removing the insulating blocks.

FIG. 15 is a structural diagram of FIG. 14 from another perspective.

FIG. 16 is a structural diagram of the motor base of the third embodiment of the present disclosure at the high-density integrated circuit module after the insulating base body is removed.

FIG. 17 is a structural diagram of FIG. 16 after the insulating blocks are removed.

In the drawings: 100, 200, motor base; 10, metal branch; 101, soldering foot; 11, first branch; 112, first connecting section; 113, 124, 152, pin; 12, second branch; 121, second extension section; 122, second connecting section; 123, second joinning section; 13, third branch; 131, third connecting section; 14, fourth branch; 141, fourth extension section; 142, fourth connecting section; 143, fourth joinning section; 15, fifth branch; 151, fifth connecting section; 20, insulating base; 21, insulating blocks; 211, first insulating block; 212, second insulating block; 213, third insulating block Edge block; 214, fourth insulating block; 215, mounting groove; 2150, platform; 2152, recessed portion; 2153, opening; 216, pit; 217, partition block; 23, insulating base body; 231, bottom; 232, first side wall: 233, second side wall; 30, first electronic component; 31, first sensing element; 32, first coil; 40, high-density integrated circuit module; 41, rigid circuit board; 410, pad; 411, conductive sheet; 412, circuit; 416, through hole; 42, high-density integrated circuit: 421, solder joint: 50, second coil: 60, sensing chip; 70, capacitor element.

### DETAILED DESCRIPTION OF THE EMBODIMENTS

The present disclosure is further described in detail below in conjunction with the accompanying drawings of the embodiments.

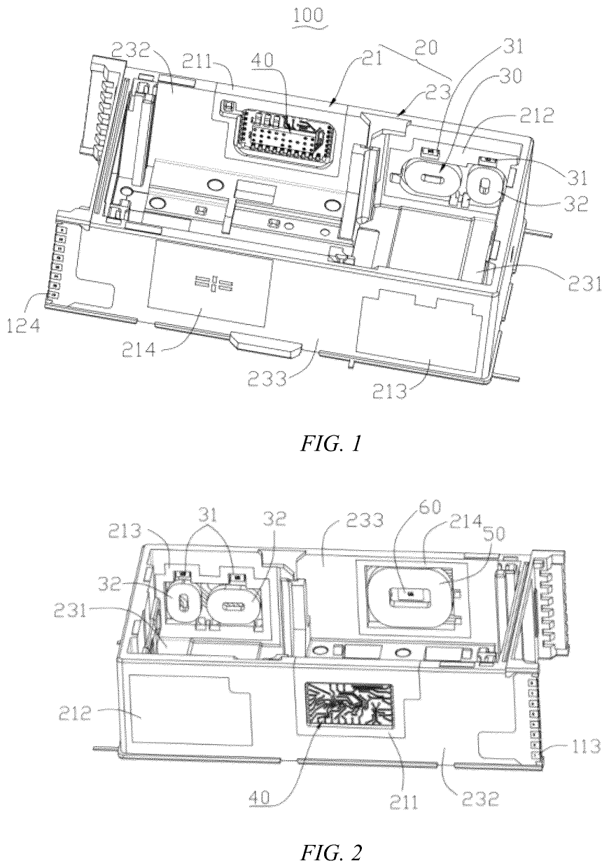

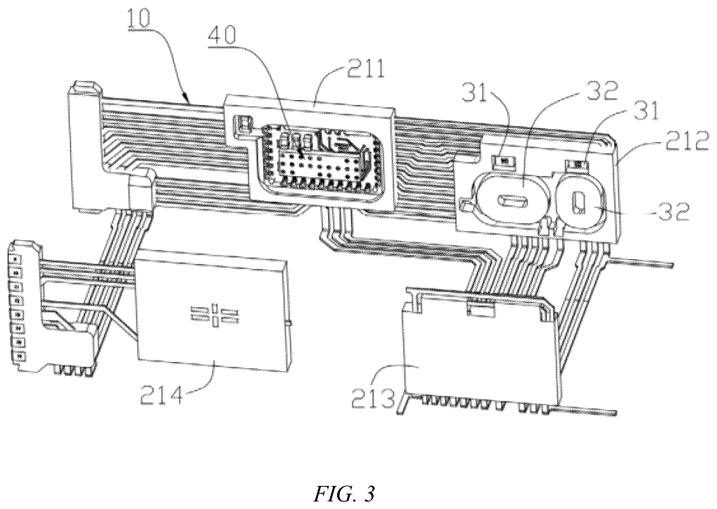

Please refer to FIGS. 1 to 3 together. A motor base 100 provided in the first embodiment of the present disclosure includes a plurality of metal branches 10, an insulating base 20 injection-molded on the plurality of metal branches 10, at least one first electronic component 30 disposed on the insulating base 20 and electrically connected to the metal branches 10, and a high-density integrated circuit module 40 disposed on the insulating base 20 and electrically connected to the first electronic component 30. In this embodiment, the insulating base 20 includes an insulating block 21 once injection-molded on the metal branches 10, and an insulating base body 23 twice injection-molded on the insulating blocks 21 and the metal branches 10.

In this embodiment, the insulating base body 23 is a three-dimensional frame structure, and the insulating base body 23 specifically includes a horizontally arranged bottom 231, a first side wall 232 and a second side wall 233 that are vertically and oppositely arranged; the insulating blocks 21 is embedded in the first side wall 232 and the second side wall 233, and multiple insulating blocks 21 can be set based on demand, and each insulating block 21 corresponds to one or more electronic components, and multiple electronic components constitute a first electronic assembly 30.

In this embodiment, the insulating blocks 21 specifically includes a first insulating block 211 and a second insulating block 212 that are embedded in the first side wall 232 at intervals, and a third insulating block 213 and a fourth insulating block 214 that are embedded in the second side wall 233 at intervals, wherein the third insulating block 213 is opposite to the second insulating block 212, and the fourth insulating block 214 is opposite to the first insulating block 211.

It can be understood that in this embodiment, the number of insulating blocks 21 is four, however, the embodiments of the present disclosure are not limited thereto, and in actual application, the number of insulating blocks 21 can be further expanded based on the number of electronic components or the number of electronic component combinations.

It can be understood that in other embodiments, the insulating base body 23 can also have only the bottom 231, that is, the first side wall 232 or the second side wall 233 or both are omitted, in which case, the insulating blocks 21 can be all arranged on the bottom 231.

In this embodiment, the first electronic component 30 disposed on the insulating blocks 21 includes at least two first sensing elements 31 with position sensing function and at least two first coils 32. The at least two first sensing elements 31 and the at least two first coils 32 are disposed on the corresponding insulating blocks 21. The first sensing element 31 may be a Hall sensor (HS), and the first coil 32 may be a wound hollow coil or a patch-type flexible printed coil (FP Coil). Specifically, in this embodiment, the number of the first sensing element 31 and the first coil 32 is four, wherein the two first sensing elements 31 and the two first coils 32 are both mounted on the inner side surface of the second insulating block 212 facing the second side wall 233, and the other two first sensing elements 31 and the other two first coils 32 are both mounted on the inner side surface of the third insulating block 213 facing the first side wall 232. The first sensing element 31 may be a Hall sensor component or an integrated circuit component including a Hall sensor, etc. Among them, the four first sensing elements 31 are used to sense the position of the first optical module (such as a prism, not shown) in real time, and the four first coils 32 are arranged opposite to each other in pairs, and are used to drive the first optical module to rotate in two different axial directions. In this embodiment, a second electronic component (not shown) is also installed on the fourth insulating block 214, and the second electronic component includes a second coil 50 and a sensing chip 60 arranged at the center of the second coil 50 for controlling the operation of the second coil 50. At least a portion of the soldering end (not shown) of the metal branches 10 are exposed to the fourth insulating block 214 to be electrically connected to the second coil 50 and the sensing chip 60. The sensing chip 60 can be a Hall sensor component or an integrated circuit component including a Hall sensor, etc.

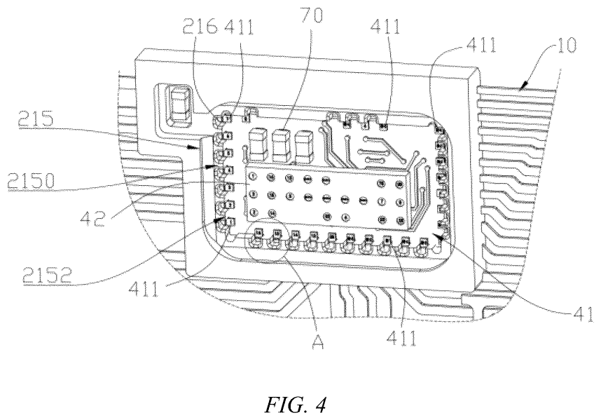

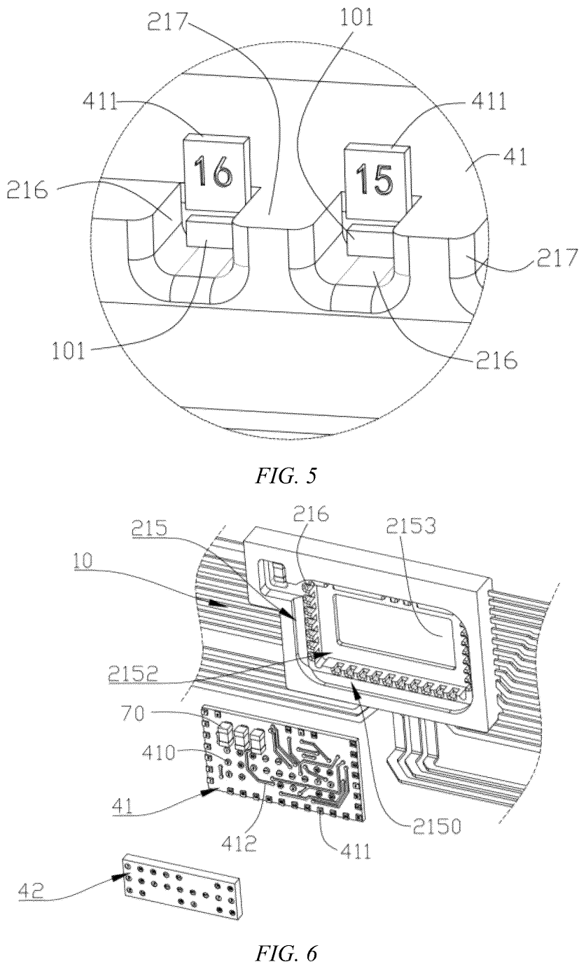

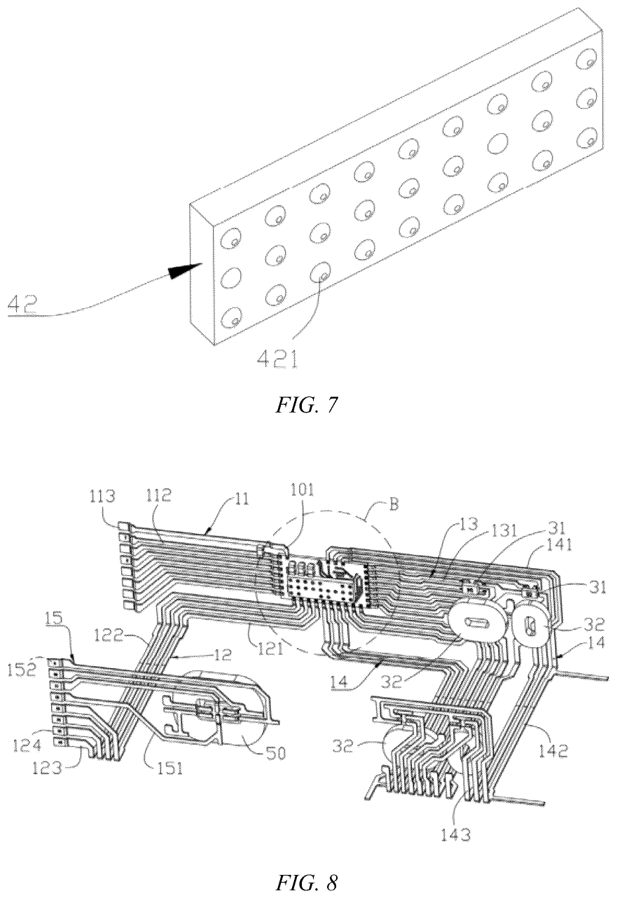

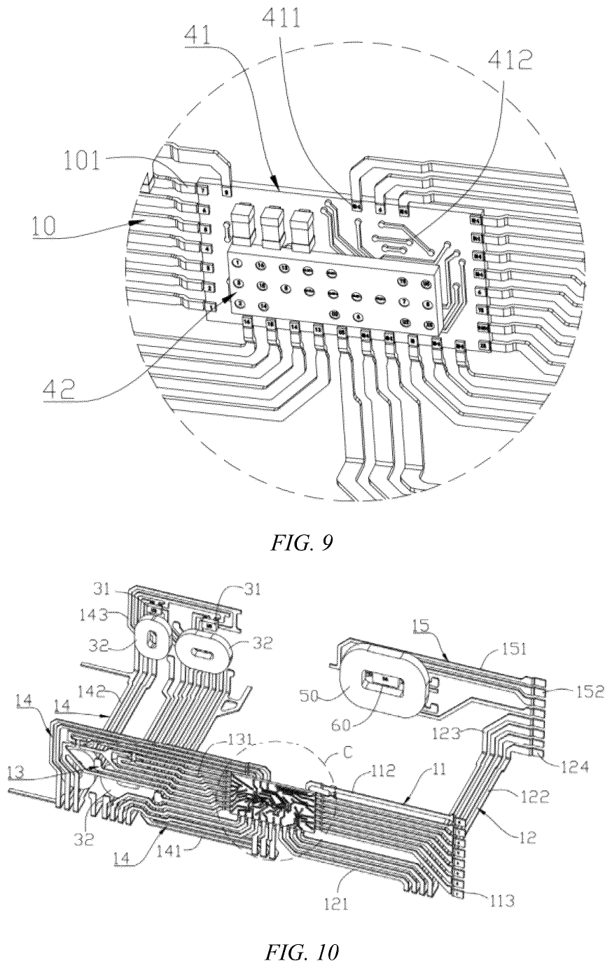

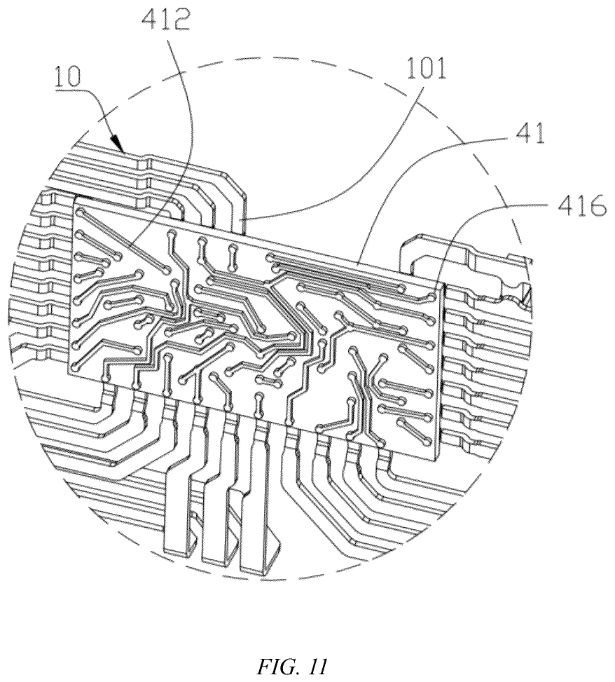

Please refer to FIG. 4 to FIG. 11. The high-density integrated circuit module 40 of the present embodiment mainly has a driving function, and therefore can also be referred to as a driving integrated circuit module, which is used to drive or control at least one first sensing element 31 and at least one first coil 32. In the present embodiment, the high-density integrated circuit module 40 and the first sensing element 31 and the first coil 32 driven by the high-density integrated circuit module 40 are arranged at intervals, so that the high-density integrated circuit module 40 and the first electronic component 30 driven by the high-density integrated circuit module 40 are located on different insulating blocks 21, that is, a part of the first sensing element 31 and the first coil 32 are arranged separately from the high-density integrated circuit module 40. The high-density integrated circuit module 40 is arranged on the insulating base 20 and includes a high-density integrated circuits 42, and the high-density integrated circuits 42 are electrically connected to the metal branches 10 embedded in the insulating base 20, so that the high-density integrated circuits 42 are electrically connected to the first electronic component 30 through the metal branches 10. A conventional Hall sensor (HS) has 4 solder joints, and a conventional integrated circuit (IC) with an integrated Hall sensor has 8 solder joints. The high-density integrated circuits 42 of the present disclosure is called High Density Integrated Circuit (HDIC for short), which is a new generation of integrated circuits. It integrates more circuit structures and solder joints 421, so that it can control or drive multiple or multiple electronic components on the motor base 100. The density of the solder joints 421 (such as solder balls or solder sheets) formed on its surface is higher than that of the Hall sensor and the integrated circuit, generally not less than eight, and twenty-seven in this embodiment, but it is not limited in other embodiments, for example, it can be ten, fifteen, twenty, etc. In this embodiment, the high-density integrated circuit module 40 specifically includes a rigid circuit board 41 disposed on the insulating base 20 and the high-density integrated circuits 42 soldered to the rigid circuit board 41. The rigid circuit board 41 is disposed at a position on the insulating base 20 away from the first electronic component 30. The rigid circuit board 41 is soldered to the metal branches 10 embedded in the insulating base 20, so that the high-density integrated circuits 42 are electrically connected to at least one first sensing element 31 and at least one first coil 32 through the metal branches 10.

In this embodiment, the high-density integrated circuits 42 are electrically connected to the plurality of first sensing elements 31 and the plurality of first coils 32 through the metal branches 10. That is, in this embodiment, the high-density integrated circuits 42 are electrically connected to the four first sensing elements 31 and the four first coils 32 through the metal branches 10. The rigid circuit board 41 is disposed on the first insulating block 211, and the rigid circuit board 41 is located on the inner side of the first insulating block 211 facing the second sidewall 233.

In this embodiment, three capacitor elements 70 are also electrically connected to the rigid circuit board 41 of the high-density integrated circuit module 40, and the capacitor elements 70 can provide better filtering function for the high-density integrated circuits 42. It can be understood that in this application, the high-density integrated circuit module 40 can be integrated or separated with the sensing element or coil controlled by it, that is, the position of the high-density integrated circuit module 40 is not limited to being located adjacent to the sensing element or coil controlled by it. Through this setting method, the positions of the high-density integrated circuit module 40 and the sensing element or coil can be dispersedly set to achieve a more flexible spatial layout, and then the control ability of the motor base 100 and the voice coil motor having it can be more refined. The rigid circuit board 41 is soldered to the metal branches 10 embedded in the insulating base 20. Specifically, at least one end of the metal branch 10 is provided with a soldering foot 101 arranged at intervals around the periphery of the rigid circuit board 41. A plurality of solder pads 410 are provided in the middle area of the rigid circuit board 41 to be soldered and fixed with solder joints 421 of the high-density integrated circuits 42. A plurality of conductive sheets 411 are provided at intervals around the periphery of the rigid circuit board 41. The rigid circuit board 41 forms a plurality of circuits 412 electrically connecting the corresponding solder pads 410 and the conductive sheets 411. The conductive sheets 411 are soldered to the corresponding soldering feet 101, thereby achieving electrical connection with the metal branches 10. In this embodiment, the conductive sheets 411 of the rigid circuit board 41 and the corresponding soldering feet 101 are arranged opposite to each other along the length or width direction of the soldering feet 101 and are soldered and connected to each other through solder paste. The circuits 412 are formed on opposite sides of the rigid circuit board 41 and are electrically connected through vias 416. Conductive sheets 411 are located on one side of the rigid circuit board 41 and are electrically connected to the corresponding circuits 412 on the other side of the rigid circuit board 41 through via 416. This prevents the solder paste from creeping along circuits 412 when the conductive sheets 411 and the soldering feet 101 are soldered by solder paste, which is commonly known as the solder creeping phenomenon. In this embodiment, the conductive sheets 411 and the high-density integrated circuits 42 are located on the same side of the rigid circuit board 41; the conductive sheets 411 of the rigid circuit board 41 and the corresponding soldering feet 101 are arranged relatively spaced apart along the length direction of the corresponding metal branches 10 and are connected to each other by soldering with solder paste, that is, the soldering feet 101 of the metal branches 10 and the corresponding conductive sheets 411 are arranged side by side, and the surfaces where the conductive sheets 411 of the rigid circuit board 41 and the soldering feet 101 of the metal branches 10 are soldered to each other are located in the same plane, that is, the conductive sheets 411 and the corresponding soldering feet 101 are flush with each other, which can not only reduce the overall thickness at the soldering points, but also facilitate the observation of the soldering effect, prevent the occurrence of empty soldering, and improve the yield. It can be understood that in other embodiments, the soldering feet 101 of the metal branches 10 and the corresponding conductive sheets 411 can also be arranged side by side, and the surface where the soldering feet 101 and the corresponding conductive sheets 411 are soldered to each other can form a certain step, that is, the soldering feet 101 and the corresponding conductive sheets 411 are located on different planes along the thickness direction of the first side wall 232, but this method will increase the thickness of the soldering point. In the present disclosure, the conductive sheets 411 can be a square or circular sheet structure formed on the surface of the rigid circuit board 41, or an arc structure formed in a circular or square through hole of the rigid circuit board 41 to form a through hole 416 together with the through hole. In this case, the soldering feet 101 of the metal branches 10 can be electrically connected to the conductive sheets 411 by inserting or pressing into the through hole 416.

In this embodiment, the high-density integrated circuits 42 and the rigid circuit board 41 are fixed by soldering with a first solder paste, and the first solder paste is a high-temperature solder paste, such as a solder paste with a melting point greater than 221° C., for example, tin-lead solder paste Sn10Pb90, melting point: 280-305° C.; tin-antimony solder paste Sn90Sb10, melting point 245-255° C.; tin-gold solder paste Au80Sn20, melting point 280° C., tin-copper solder paste Sn-CU3.0, melting point: 227-320° C. The conductive sheets 411 of the rigid circuit board 41 are connected to the soldering feet 101 of the metal branches 10 by soldering with a second solder paste. The second solder paste is a medium-low temperature solder paste, and its melting point is less than the melting point of the high-temperature solder paste. For example, it can be a solder paste with a melting point less than or equal to 221° C., for example, SAC305° C., melting point 217-221° C., SAC3507, melting point 217° C. Therefore, the first solder paste, i.e., the high-temperature solder paste, and the second solder paste, i.e., the low-temperature solder paste, have different solder paste materials and components. In specific applications, the difference in the solder paste used can be determined by measuring and comparing their materials, components and melting points. Preferably, the high-density integrated circuits 42 and the rigid circuit board 41, as well as the rigid circuit board 41 and the metal branches 10, are both soldered and fixed by reflow soldering.

In this embodiment, the inner side surface of the first insulating block 211 of the insulating base 20 is further recessed inward to form a mounting groove 215, and the rigid circuit board 41 is received in the mounting groove 215, and at least part of the soldering feet 101 of the metal branches 10 are embedded in one side or the periphery of the mounting groove 215. A platform 2150 is further formed at the periphery of the mounting groove 215, and the mounting groove 215 includes a recessed portion 2152 recessed from the platform 2150, and the rigid circuit board 41 is received in the recessed portion 2152. The bottom of the recessed portion 2152 further forms an opening 2153 that communicates with the outside world, and the rigid circuit board 41 communicates with the outside world through the opening 2153, thereby improving the heat dissipation effect of the high-density integrated circuit module 40. The platform 2150 is provided with a plurality of pits 216 for exposing the soldering feet 101 corresponding to the soldering feet 101 of the metal branches 10, which can facilitate the soldering of the metal branches 10 and the rigid circuit board 41, and a partition block 217 is formed between each two adjacent pits 216 to avoid short circuits during the soldering process. In other embodiments, the mounting groove 215 can be further filled with glue to encapsulate the high-density integrated circuit module 40, which not only has a protective effect, but also improves the waterproof performance.

In this embodiment, the rigid circuit board 41 can be a ceramic substrate or a rigid printed circuit board (Rigid Printed Circuit Board, RPCB for short) or an integrally formed part of an etched circuit and a plastic base. Among them, the rigid printed circuit board is mainly made by stacking copper foil and resin materials, and the ceramic substrate can be formed into a single-layer ceramic substrate with a double-layer circuit through the DPC, DBC process, or a multi-layer ceramic substrate with a multi-layer circuit (more than two layers) through the HTCC, LTCC or other processes.

In this embodiment, the plurality of metal branches 10 include a plurality of first branches 11, a plurality of second branches 12, a plurality of third branches 13, a plurality of fourth branches 14 and a plurality of fifth branches 15.

A plurality of first branches 11 are embedded in the first side wall 232 in a side-by-side and spaced relationship along the height direction of the first side wall 232. The first branch 11 includes a first connecting section 112. One end of the first connecting section 112 of the plurality of first branches 11 forms soldering feet 101 soldered to the conductive sheets 411 on the rigid circuit board 41. The other end of the first connecting section 112 of the plurality of the first branches 11 forms a pin 113 exposed outside the first side wall 232 for connecting to an external circuit. The second branch 12 includes a second extension section 121 embedded in the first side wall 232, a second connecting section 122 embedded in the bottom 231 and a second joining section 123 embedded in the second side wall 233. The second extension section 121, the second connecting section 122 and the second joining section 123 are connected in sequence. The free end of the second extension section 121 is provided with soldering foot 101 soldered to the conductive sheets 411 on the rigid circuit board 41. The second joining section 123 forms a pin 124 exposed outside the second side wall 233 for connecting to an external circuit.

The third branch 13 and the first branch 11 are respectively arranged at opposite ends of the rigid circuit board 41. A plurality of third branches 13 are embedded in the first side wall 232 in parallel and at intervals. The third branch 13 includes a third connecting section 131. One end of the third connecting section 131 of the third branche 13 forms soldering feet 101 for soldering with the conductive sheets 411 on the rigid circuit board 41. The other end of at least some of the third connecting sections 131 of the third branch 13 forms a soldering end (not marked) for soldering with the first sensing element 31 and the first coil 32 on the first side wall 232.

The fourth branch 14 includes a fourth extension section 141 embedded in the first side wall 232, a fourth connecting section 142 embedded in the bottom 231 and a fourth joining section 143 embedded in the second side wall 233. The fourth extension section 141, the fourth connecting section 142 and the fourth joining section 143 are connected in sequence. The free ends of the fourth extension sections 141 of the fourth branches 14 are provided with soldering feet 101 soldered to the conductive sheets 411 on the rigid circuit board 41. At least part of the fourth extension sections 141 are provided with soldering ends (not marked) soldered to the first sensing element 31 and the first coil 32 on the first side wall 232; at least part of the fourth connecting sections 143 are provided with soldering ends (not marked) soldered to the first sensing element 31 and the first coil 32 on the second side wall 233.

Multiple fifth branches 15 are embedded in the second side wall 233 in parallel and spaced apart along the height direction of the second side wall 233. The fifth branch 15 includes a fifth connecting segment 151. One end of the fifth connecting segment 151 of the multiple fifth branches 15 forms a pin 152 exposed outside the second side wall 233 for connecting to an external circuit. At least part of the fifth connecting segments 151 of the fifth branch 15 have a soldering end (not marked) soldered to the second coil 50 and the sensing chip 60.

The four first sensing elements 31 of this embodiment are used to sense the position of the first optical module (e.g, prism) in real time. The four first coils 32 form two pairs for driving the first optical module to rotate in two different axial directions. The high-density integrated circuits 42 identifies the position of the first optical module from different directions according to the signals output by the four first sensing elements 31, and determines the control value including the current intensity and direction applied to the first coil 32 based on the identified position information to achieve the purpose of controlling the current to drive the first coil 32, and uses the determined control value to feedback control the position of the first optical module, thereby achieving the function of optical image stabilization (OIS).

The sensing chip 60 located opposite the high-density integrated circuit module 40 is used to sense the position of the second optical module (such as a lens, not shown) and provide corresponding current to the corresponding coil according to the position information, thereby driving the lens to move and achieving the function of zooming or focusing.

It is understandable that the present application is not limited to superimposing more sensing elements and coils having the same functions as the first sensing element 31, the first coil 32 and the capacitor element 70 to expand the control capability of the motor base 100.

The embodiment of the present disclosure further provides a method for manufacturing the motor base 100, comprising the following steps:
S1. Providing a plurality of metal branches 10. In this embodiment, a plurality of metal branches 10 are formed on the same material strip, and in the initial state, the plurality of metal branches 10 are arranged horizontally.
S2. Injection molding at least a portion of the insulating base 20 on the metal branches 10; in this embodiment, multiple insulating blocks 21 are injection molded at the metal branches 10 at one time to form a portion of the insulating base 20. Specifically, the insulating blocks 21 include a first insulating block 211, a second insulating block 212, a third insulating block 213, and a fourth insulating block 214, all of which are arranged horizontally and at intervals.
S3, install at least one first electronic component 30 on the insulating base 20 and electrically connect the metal branches 10: In this embodiment, the first electronic component 30 and the second electronic component are installed on the second insulating block 212, the third insulating block 213 and the fourth insulating block 214 corresponding to the insulating base 20 and directly soldered to the corresponding metal branches 10.
S4, provide a rigid circuit board 41, the rigid circuit board 41 is provided with a plurality of conductive sheets 411 arranged at intervals, solder the high-density integrated circuits 42 to the rigid circuit board 41 to form a high-density integrated circuit module 40, and electrically connect the conductive sheets 411 arranged on the rigid circuit board 41 to the metal branches 10 embedded in the insulating base 20 so that the high-density integrated circuits 42 are electrically connected to the first sensing element 31 and the first coil 32 of the first electronic component 30 through the metal branches 10. Specifically, in this embodiment, the high-density integrated circuit module 40 is horizontally mounted on the first insulating block 211, and the conductive sheets 411 of the rigid circuit board 41 are soldered to the soldering feet 101 of the metal branches 10 embedded in the first insulating block 211.
S5, bend the metal branches 10 so that the insulating blocks 21, the high-density integrated circuit module 40, the first electronic component 30 and the second electronic component are all transformed from a horizontal position to a vertical position or are located in a vertical plane. Specifically, in this embodiment, the metal branches 10 are bent so that the first insulating block 211 and the second insulating block 212 are located in the vertical plane where the first side wall 232 is located, and the third insulating block 213 and the fourth insulating block 214 are located in the vertical plane where the second side wall 233 is located; S6, perform secondary injection molding on the metal branches 10 and the insulating blocks 21 to obtain the insulating base body 23, thereby forming the insulating base 20.

The motor base 100 of this embodiment can be applied to a periscope voice coil motor, on which a high-density integrated circuits 42 are integrated. The high-density integrated circuits 42 are soldered to a rigid circuit board 41 to form a high-density integrated circuit module 40. The rigid circuit board 41 is soldered to the metal branches 10 embedded in an insulating base 20, so that the high-density integrated circuits 42 are electrically connected to the first sensing element 31 and the first coil 32 through the metal branches 10. Compared with the split control form of using multiple integrated circuits to control multiple Hall sensors respectively in the prior art, the motor base 100 uses a high-density integrated circuits 42 to control multiple or multiple electronic components at the same time, that is, the integrated control replaces the split control of the prior art, so that the high-density integrated circuits 42 can achieve more abundant control functions to meet the needs of the periscope voice coil motor.

In addition, the high-density integrated circuits 42 are independently set on the rigid circuit board 41, which can be more suitable for integrating complex circuits. It will not be limited by the circuit layout space of the metal branches 10 of the insulating base 20 and cannot realize the setting of complex control circuits. At the same time, it can also more reasonably utilize the circuit layout space of the motor base 100 so that electronic components such as coils and high-density integrated circuits 42 can be installed on the motor base 100 in a more reasonable spatial layout form, allowing the high-density integrated circuits 42 to utilize a larger space to achieve richer control functions.

In addition, in this embodiment, the high-density integrated circuit module 40 is soldered and assembled with the metal branches 10 as an independent unit, which is more convenient for later maintenance and replacement of components.

In the prior art, some voice coil motor bases 100 use flexible circuit boards to integrate coils, sensors, etc. However, the flexible circuit board not only has a higher manufacturing cost, but also is inconvenient for automated operation and assembly positioning due to the easy deformation of the flexible circuit board during the assembly process, and has poor reliability. The motor base 100 of this embodiment uses a rigid circuit board 41, which has high structural strength, is not easy to deform, and is more convenient for automated assembly and positioning: and in the prior art, in order to achieve miniaturization, the motor base 100 is usually small in size, resulting in a thin thickness of the first side wall 232 and the second side wall 233. At this time, the metal branches 10 embedded in the first side wall 232 and the second side wall 233 can not only realize the conduction of the circuit, but also increase the strength of the first side wall 232 and the second side wall 233. When a circuit board is required, the motor base 100 will no longer be embedded with the metal branches 10 at the circuit board, and further structures such as the mounting groove 215 and the opening 2153 for mounting the circuit board need to be provided, which greatly reduces the structural strength of the motor base 100. Therefore, in this embodiment, a rigid circuit board 41 with greater structural strength is used to increase the structural strength of the motor base 100 at the circuit board. In addition, the rigid circuit board 41 preferably uses a ceramic substrate, which has excellent electrical insulation performance and high thermal conductivity, and can further improve the heat dissipation effect of the high-density integrated circuit module 40. In addition, the high-density integrated circuits 42 usually uses semiconductor materials such as SiC (silicon carbide) or GaN (gallium nitride), which are closer to the thermal expansion coefficient of the ceramic substrate. Therefore, the deformation coefficients of the two are close during thermal expansion, and their matching performance is more stable. When the ceramic substrate is used first, the pad 410, the conductive sheets 411 and the circuits 412 thereon are preferably formed by the DPC process, that is, the pad 410, the conductive sheets 411 and the circuits 412 are plated on the surface of the ceramic substrate by electroplating. The line width of the circuit formed by the stamping terminal is generally not less than 100 microns. The line width of the circuit formed by the rigid printed circuit board (RPCB) is generally not less than 70 microns. If it is to be less than 70 microns, the yield will be greatly reduced, and the cost will be greatly increased. If the line width of the circuit using the ceramic substrate is greater than or equal to 20 microns and less than or equal to 70 microns, the minimum can be 20 microns while ensuring the yield and cost. Therefore, the use of a ceramic substrate can greatly improve the arrangement density and elasticity of the circuit. The material of the ceramic substrate can be selected from aluminum oxide or silicon nitride. Aluminum oxide has a higher thermal conductivity, while silicon nitride has a higher structural strength. In this embodiment, the soldering feet 101 of the metal branches 10 are arranged around the periphery of the rigid circuit board 41, reducing the extension path, which not only simplifies the structure of the metal branches 10 and reduces the manufacturing cost, but also facilitates the soldering of the conductive sheets 411 of the rigid circuit board 41 and the soldering feet 101 of the metal branches 10, reducing the manufacturing difficulty.

In this embodiment, the insulating base 20 is provided with a mounting groove 215 for accommodating the rigid circuit board 41, which can further improve the reliability of the installation of the rigid circuit board 41. In addition, a platform 2150 is formed on the periphery of the mounting groove 215. The mounting groove 215 includes a recessed portion 2152 recessed from the platform 2150. The rigid circuit board 41 is accommodated in the recessed portion 2152, which not only can better position the rigid circuit board 41, but also further increases the accommodation space for the high-density integrated circuits 42. In this way, the high-density integrated circuit module 40 can be completely accommodated in the mounting groove 215, further reducing the thickness of the motor base 100, saving thickness space, and conforming to the development trend of miniaturization. The platform 2150 is provided with a plurality of pits 216 for exposing the soldering feet 101 of the metal branches 10, which can facilitate the soldering of the metal branches 10 and the rigid circuit board 41, and a partition block 217 is formed between each two adjacent pits 216 to avoid short circuits and overlaps during soldering.

In this embodiment, the high-density integrated circuits 42 and the rigid circuit board 41 are fixed by soldering through the first solder paste, i.e., the high-temperature solder paste, and the rigid circuit board 41 and the metal branches 10 are fixed by soldering through the second solder paste, i.e., the medium-low temperature solder paste. The melting point of the high-temperature solder paste is greater than the melting point of the medium-low temperature solder paste, which can prevent the high-density integrated circuits 42 and the rigid circuit board 41 from melting and disconnecting when the high-density integrated circuit module 40 passes through the circuit board reflow furnace.

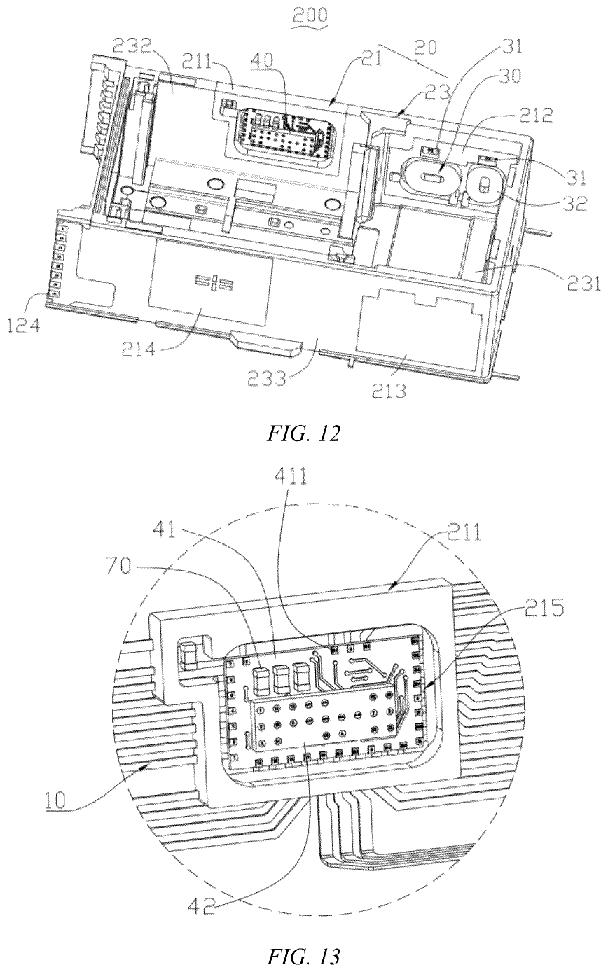

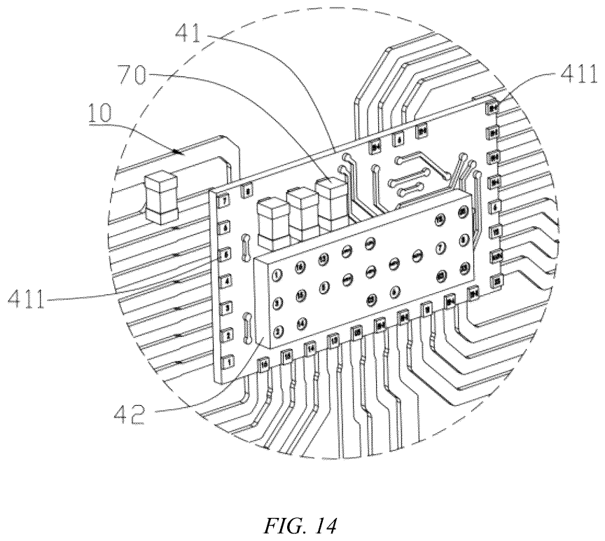

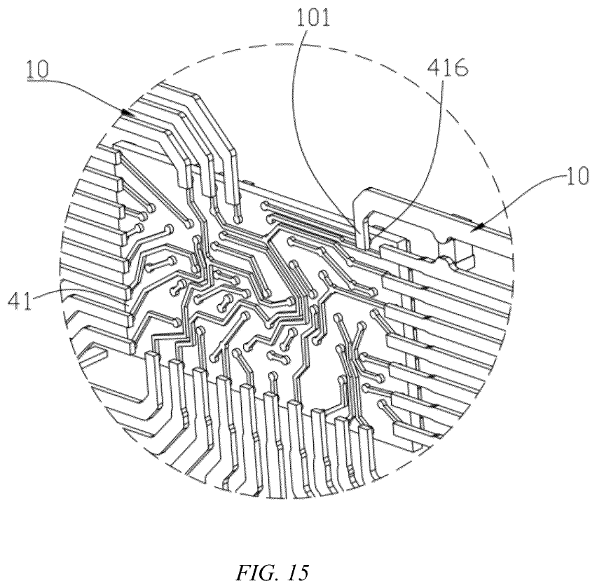

Please refer to FIGS. 12 to 15 together. The second embodiment of the present disclosure provides a motor base 200, which has a structure that is roughly the same as the structure of the motor base 100 of the first embodiment, and the difference mainly lies in the soldering method between the soldering feet 101 of the metal branches 10 and the rigid circuit board 41. In this embodiment, the soldering feet 101 of the metal branches 10 are located on the side of the rigid circuit board 41 facing away from the conductive sheets 411. A plurality via holes 416 are provided on the rigid circuit board 41. The soldering feet 101 of the metal branches 10 are electrically connected to the corresponding conductive sheets 411 through the via holes 416. That is, in this embodiment, the soldering feet 101 of the metal branches 10 are soldered to the corresponding conductive sheets 411 through the through-hole connection technology, which can prevent tin creeping when soldering the conductive sheets 411 and the metal branches 10, thereby improving the soldering quality.

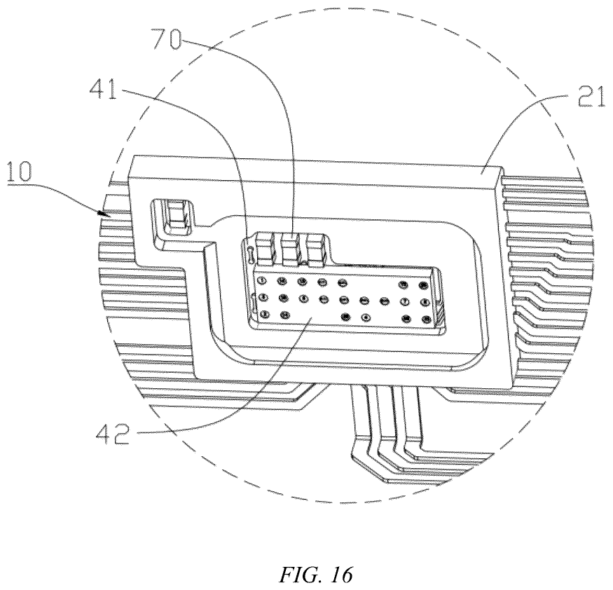

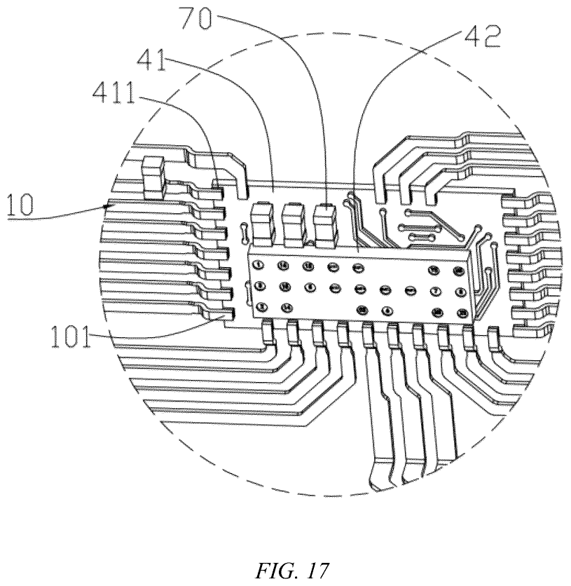

Please refer to FIG. 16 and FIG. 17 together. The third embodiment of the present disclosure provides a motor base, and its structure is substantially the same as that of the motor base 100 of the first embodiment. The difference mainly lies in the soldering method between the soldering feet 101 of the metal branches 10 and the rigid circuit board 41. In this embodiment, the conductive sheets 411 of the rigid circuit board 41 and the corresponding soldering feet 101 are stacked in the thickness direction of the soldering feet 101 and are soldered to each other. However, this method will increase the thickness at the soldering point and is not conducive to observing whether there will be empty soldering at the soldering point. It can be understood that the rigid circuit board 41 is not limited to being set on the insulating blocks 21 of the first injection molding, and it can also be set on the insulating base body 23 of the second injection molding and soldered with the metal branches 10 embedded in the insulating base body 23, and the rigid circuit board 41 can be set not only on the side wall of the insulating base body 23, but also on the bottom 231 of the insulating base body 23. At this time, the inner surface of the insulating base body 23 may be recessed inward to form a mounting groove 215, and the rigid circuit board 41 is accommodated in the mounting groove 215. The structure of the mounting groove 215 may be the same as that of the first embodiment. In this embodiment, the manufacturing method of the motor base 100 may include the following steps: S1, forming a plurality of independent metal branches 10 on the same material strip, and in the initial state, the plurality of metal branches 10 are arranged horizontally;
S2, once-injection molding the insulating blocks 21 at the metal branches 10;
S3, twice-injection molding on the metal branches 10 and the insulating blocks 21 to obtain the insulating base body 23, and then forming the insulating base 20, and then horizontally installing the rigid circuit board 41 of the high-density integrated circuit module 40 to the bottom 231 of the insulating base body 23, and soldering it with the metal branches 10 embedded in the insulating base body 23.

In this embodiment, the rigid circuit board 41 is installed on the insulating base body 23 obtained by secondary injection molding, and the rigid circuit board 41 is horizontally installed on the bottom 231 of the insulating base body 23 to facilitate soldering.

In the above embodiments, the insulating blocks 21 or the insulating base body 23 is first obtained by injection molding, and then the rigid circuit board 41 is installed on the insulating blocks 21 or the insulating base body 23. It can be understood that in other embodiments, the rigid circuit board 41 can also be soldered to the metal branches 10 first, and then the insulating blocks 21 or the insulating base body 23 is formed by injection molding on the rigid circuit board 41 and the metal branches 10. At this time, the manufacturing method of the motor base 100 may include the following steps:
S1, forming a plurality of independent metal branches 10 on a same material strip, and in the initial state, the plurality of metal branches 10 are arranged horizontally;
S2, soldering the rigid circuit board 41 of the high-density integrated circuit module 40 to the metal branches 10, and once injecting the insulating blocks 21 on the metal branches 10 and the rigid circuit board 41, so that the periphery of the rigid circuit board 41 is embedded in the insulating blocks 21, as shown in FIG. 16, the insulating base body 23 is obtained by secondary injection molding on the metal branches 10 and the insulating blocks 21, thereby forming the insulating base 20;
Or, the rigid circuit board 41 of the high-density integrated circuit module 40 is soldered to the metal branches 10, the insulating blocks 21 are once injection molded on the metal branches 10, and then the insulating base body 23 is obtained by secondary injection molding on the metal branches 10, the insulating blocks 21 and the rigid circuit board 41, thereby forming the insulating base 20, so that the periphery of the rigid circuit board 41 is embedded in the insulating base body 23:
Or, the rigid circuit board 41 of the high-density integrated circuit module 40 is soldered to the metal branches 10, and the insulating base body 23 is once injection molded on the metal branches 10 and the rigid circuit board 41, so that the periphery of the rigid circuit board 41 is embedded in the insulating base body 23, thereby forming the insulating base 20, that is, the insulating base body 23 can also be obtained by one-time injection molding.

In this embodiment, the high-density integrated circuit module 40 is first soldered to the metal branches 10, and then the rigid circuit board 41 is embedded in the insulating base body 23 or the insulating blocks 21 by injection molding technology during the molding process of the motor base 100, which can further omit the process or increase the reliability of the connection: and because the high-density integrated circuit module 40 is first soldered to the metal branches 10 in this embodiment, the high-density integrated circuit module 40 can be conveniently set on the bottom 231 or side wall of the insulating base body 23 in this embodiment, and the position of the high-density integrated circuit module 40 on the motor base 100 can be more flexibly arranged.

The present disclosure further provides a voice coil motor, the voice coil motor includes the motor base 100, 200, a first optical module (not shown) located in the motor base 100, 200 and matched with the motor base 100, 200, the first optical module is located at the first electronic component 30 and includes a magnetic element (not shown) matched with the first electronic component 30, the magnetic element can be a magnet or a sensing magnet, etc. The first optical module can be a module with optical elements such as a prism.

The present disclosure further provides another voice coil motor, the voice coil motor includes the motor base 100, 200, and a second optical module matched with the motor base 100, 200, the second optical module includes a second magnetic element located at the second electronic component and respectively matched with the second electronic component, the magnetic element can be a magnet or a sensing magnet, etc. The second optical module can be a module with optical elements such as a lens.

It is understood that the motor base 100, 200 is not limited to being used in a periscope voice coil motor, and it can also be used in other types of voice coil motors.

It is understood that the first electronic component 30 is not limited to including the first coil 32 and the first sensing element 31 of this embodiment, and it can also include other types of electronic devices.

It is understood that the number of the first coil 32 and the first sensing element 31 is not limited to this embodiment, and it can also be set to other numbers as needed.

It is understood that the first electronic component 30 is not limited to being set on the insulating blocks 21 of one-time injection molding, and it can also be set on the insulating base body 23 at a position away from the rigid circuit board 41.

The technical features of the above-mentioned embodiments can be combined arbitrarily. In order to make the description concise, all possible combinations of the technical features in the above-mentioned embodiments are not described. However, as long as there is no contradiction in the combination of these technical features, they should be considered to be within the scope of this specification.

The above-mentioned embodiments only express the implementation of the present disclosure, and the description is relatively specific and detailed, but it cannot be understood as limiting the scope of the patent of the present disclosure. It should be noted that, for those skilled in the art, several modifications and improvements can be made without departing from the concept of the present disclosure, and these modifications and improvements all belong to the protection scope of the present disclosure. Therefore, the protection scope of the present disclosure shall be subject to the attached claims.

1. A motor base, characterized in that it comprises a plurality of metal branches, an insulating base injection-molded on the plurality of metal branches, at least one first electronic component mounted on the insulating base and electrically connected to the metal branches, the first electronic component and the high-density integrated circuit module are relatively spaced and separately arranged, and a high-density integrated circuit module, wherein the high-density integrated circuit module comprises a rigid circuit board and a high-density integrated circuit soldered to the rigid circuit board, wherein the rigid circuit board is provided with a plurality of conductive sheets arranged at intervals, the conductive sheets are electrically connected and fixed to the metal branchs embedded in the insulating base so that the high-density integrated circuit is electrically connected to the first electronic component through the metal branches, the first electronic component includes a first sensing element with a position sensing function and a first coil, the high-density integrated circuit module is simultaneously and electrically connected to the first sensing element and the first coil through the metal branches.

2. The motor base as claimed in claim 1, characterized in that the high-density integrated circuit has at least eight solder joints, the rigid circuit board has at least eight solder pads corresponding to the at least eight solder joints and fixed by soldering, the rigid circuit board forms a plurality of circuits electrically connecting the corresponding solder pads and the conductive sheets, and the conductive sheets of the rigid circuit board are fixed by soldering to the metal branches in the insulating base.

3. The motor base according to claim 1, characterized in that the first sensing element and the first coil are directly soldered to the corresponding metal branches, and the high-density integrated circuit module implements a sensing function according to the first sensing element and then outputs a control signal to control the current to drive the first coil.

4. The motor base according to claim 1, characterized in that at least one end of the metal branches are provided with soldering feet arranged at intervals around the periphery of the rigid circuit board, the conductive sheet is arranged on the periphery of the rigid circuit board and is soldered and fixed with the corresponding soldering foot.

5. The motor base according to claim 4, characterized in that the insulating base is recessed inward to form an installation groove, the high-density integrated circuit module is accommodated in the installation groove, and the soldering feet of at least part of the metal branches are embedded in one side or periphery of the installation groove.

6. The motor base according to claim 5, characterized in that a platform is formed on the periphery of the mounting groove, the mounting groove includes a recessed portion recessed from the platform, and the rigid circuit board is accommodated in the recessed portion.

7. The motor base according to claim 6, characterized in that the platform has a plurality of pits corresponding to the soldering feet of the metal branches, the soldering feet are embedded in the corresponding pits to be exposed outside the insulating base, and a partition block is formed between each two adjacent pits.

8. The motor base according to claim 5, characterized in that the conductive sheets of the rigid circuit board and the corresponding soldering feet are arranged opposite to each other along the length or width direction of the soldering feet and are soldered and connected to each other through solder paste.

9. The motor base according to claim 8, characterized in that the surfaces where the conductive sheets of the rigid circuit board and the soldering feet are soldered to each other are located in the same plane.

10. The motor base according to claim 5, characterized in that the conductive sheets of the rigid circuit board and the corresponding soldering feet are stacked and soldered to each other along the thickness direction of the soldering feet.

11. The motor base according to claim 2, characterized in that a plurality of via holes are provided on the rigid circuit board, the circuits are formed on opposite sides of the rigid circuit board and are electrically connected through the via holes, and the conductive sheets are located on one side of the rigid circuit board and are electrically connected to the corresponding circuits on the other side of the rigid circuit board through the via holes.

12. The motor base according to claim 1, characterized in that the rigid circuit board is a ceramic substrate or a rigid printed circuit board or an integrally formed part of an etched circuit and a plastic base.

13. The motor base according to claim 12, characterized in that when the rigid circuit board is a ceramic substrate, the surfaces of opposite sides of the ceramic substrate are plated to form the conductive sheets and the circuits electrically connected to the conductive sheet, and the line width of the circuit is greater than or equal to 20 microns and less than or equal to 70 microns.

14. The motor base as claimed in claim 1, characterized in that the high-density integrated circuit and the rigid circuit board are fixed by first solder paste soldering, the conductive sheets of the rigid circuit board and the metal branches are fixed by second solder paste soldering, the melting point of the first solder paste is greater than the melting point of the second solder paste, and the high-density integrated circuit and the rigid circuit board, as well as the rigid circuit board and the metal branches, are fixed by reflow soldering.

15. The motor base as claimed in claim 1, characterized in that the rigid circuit board is also electrically connected to a plurality of capacitor elements.

16. The motor base as claimed in claim 1, characterized in that the insulating base includes at least two separately arranged insulating blocks that are once-injected on the metal branches and an insulating base body that is twice-injected on the insulating blocks and the metal branches, and the high-density integrated circuit module and the first electronic component are respectively arranged on at least two of the insulating blocks.

17. The motor base according to claim 16, characterized in that the insulating base body includes a horizontally arranged bottom, a first side wall and a second side wall arranged vertically and oppositely, the insulating blocks include a first insulating block and a second insulating block embedded in the first side wall at intervals, and a third insulating block embedded in the second side wall and opposite to the second insulating block, the high-density integrated circuit module is fixed to the first insulating block, and the second insulating block and the third insulating block are all provided with the first electronic component.

18. The motor base according to claim 17, characterized in that the insulating blocks also includes a fourth insulating block embedded in the second side wall and spaced from the third insulating block, a second electronic component is installed on the fourth insulating block, at least part of the metal branches are provided with a soldering end exposed to the fourth insulating block, the soldering end is electrically connected to the second electronic component, the second electronic component includes a second coil and a sensing chip arranged at the center of the second coil for controlling the operation of the second coil, and the high-density integrated circuit module is arranged opposite to the second electronic component.

19. A voice coil motor, characterized in that it comprises the motor base according to claim 1 and a first optical module cooperating with the motor base and located at the first electronic component; the first optical module is fixed with an optical element and comprises a first magnetic element cooperating with the first electronic component.

20. A voice coil motor, characterized in that it comprises the motor base according to claim 18 and a second optical module cooperating with the motor base and located at the second electronic component; the second optical module comprises a second magnetic element cooperating with the second electronic component.

21. A method for manufacturing the motor base of claim 1, characterized in that it comprises the following steps:
S1, providing a plurality of said metal branches;
S2, injection molding at least a portion of said insulating base on said metal branches;
S3, installing at least one of said first electronic components on said insulating base and electrically connecting said metal branches;
S4, providing a said rigid circuit board, said rigid circuit board being provided with a plurality of said conductive sheets arranged at intervals, soldering said high-density integrated circuit to said rigid circuit board to form a high-density integrated circuit module, electrically connecting said conductive sheet arranged on said rigid circuit board to said metal branches embedded in said insulating base, so that said high-density integrated circuit is electrically connected to said first electronic component through said metal branches.

22. The manufacturing method of the motor base as claimed in claim 21 is characterized in that,
In S1, in the initial state, a plurality of the metal branches are arranged horizontally;
In S2, three of first insulating blocks, second insulating blocks and third insulating blocks which are arranged separately are injection molded at the metal branches at one time to form a part of the insulating base, and the first insulating block, the second insulating block and the third insulating block are all arranged horizontally;
In S3, the first electronic component is horizontally mounted on the second insulating block and the third insulating block and directly soldered to the corresponding metal branches;
In S4, the high-density integrated circuit module is horizontally mounted on the first insulating block, and the conductive sheets of the rigid circuit board are soldered to the corresponding metal branches.

23. The manufacturing method of the motor base as claimed in claim 22 is characterized in that it also includes the following steps: S5, bending the metal branches so that the first insulating block, the high-density integrated circuit module installed on the first insulating block, the second insulating block, the third insulating block and the first electronic component installed on the second insulating block and the third insulating block are all converted from a horizontal position to a vertical position: S6, secondary injection molding is performed on the metal branches, the first insulating block, the second insulating block and the third insulating block to obtain an insulating base body, thereby forming the insulating base.
